(19) United States
(12) Patent Application Publication
(10) Pub. No.: US 2005/0061890 A1
(43) Pub. Date: Mar. 24, 2005

(54) Apparatus, system, and method for identification and tracking

(76) Inventor: C. Martin Hinckley, Perry, UT (US)

Correspondence Address: KUNZLER & ASSOCIATES, 8 EAST BROADWAY, SALT LAKE CITY, UT, 84111, US

(21) Appl. No.: 10/913,825

(22) Filed: Aug. 6, 2004

Related U.S. Application Data
(60) Provisional application No. 60/501,797, filed on Sep. 10, 2003.

(51) Int. Cl. G06K 19/06

(52) U.S. Cl. 235/494

(57) ABSTRACT

An apparatus, system, and method are disclosed for identification and tracking. The apparatus includes a carrier medium and an identification code. The carrier medium may be semi-permanently disposed on an application surface of a target subject. The target subject may be a human or an animal. The application surface is substantially smooth and durable. The identification code is disposed on the carrier medium and includes an encoded identifier of identification information that corresponds to the target subject. The described apparatus, system, and method advantageously provide better identification and tracking of identification information for the target subject.

### CROSS-REFERENCES TO RELATED APPLICATIONS

This application claims the benefit of U.S. Provisional Patent Application No. 60/501,797 entitled “Apparatus, System, and Method for Identification and Tracking” and filed on Sep. 10, 2003 for C. Martin Hinckley, which is incorporated herein by reference.

### BACKGROUND

1. Technological Field

Embodiments of the invention relate to labeling and identification and, more particularly, relate to using an identification code to identify a target subject, such as a human or animal.

2. Description of the Related Art

Various types of identification methods are currently employed in all different industries to identify and track individuals, animals, packages, inventory, and so forth. Among the conventional technologies directed at identifying and tracking individuals and animals are several practical methods and systems, as well as many impractical methods and systems.

Some of the more common identification techniques include tagging humans or animals with a visual identifier. In the case of animals, this may mean branding an animal, fastening a color-coded identifier to the animal's ear, or placing a band around the animals neck or leg. In the case of humans, identification techniques vary depending on the desired permanency of the identification system. Among the practical and accepted identification techniques are stamping the back of a person's hand, placing a wristband or ankle-band around an arm or leg, attaching a badge to the person's clothing or to a lanyard around the person's neck. More permanent methods also may be employed, but may be considered outside the technological field of the present invention.

One of the disadvantages of conventional identification techniques is the limited capability of identifying a person with substantial amounts of information. For example, at amusement parks an individual patron may be identified with only a colored hand stamp. In another example, a hospital patient may be identified by a plasticized wristband on which the patient's name and other limited information may be printed. While other methods exist to identify an individual with larger amounts of data, the detachability of such devices usually becomes greater allowing the identification devices to be lost or otherwise misplaced. In another extreme, some identification devices are more permanently placed on or even within the person, e.g., sub-epidermal capsules containing electronic transmitters, which may lead to obvious health risks and difficult market acceptance.

Another disadvantage with conventional identification techniques is the permanency of the devices and mechanisms used to dispose the identification information on a human or animal. In most instances, stamps may be washed off, bands may be cut or torn, badges may be unclipped, stickers may fail to adhere, and so forth. In fact, in some instances, such as during medical procedures, such identification bands may be cut off to aid in accessing a particular area or appendage, despite the need for continued identification. Likewise, identification devices that are attached to a person's clothing is likely to be lost or removed during a medical procedure in which the medical staff must access an area of the body underneath the person's clothing. Furthermore, in the case of electronic devices, such devices may fail to operate due to failures in the electronics or power supply. Additionally, the effects of extraneous radio waves on the operational integrity of such electronic devices may be unknown or even detrimental.

From the foregoing discussion, it should be apparent that a need exists for an apparatus, system, and method to identify and track a target subject that overcomes these and other disadvantages of convention identification and tracking technologies. Beneficially, such an apparatus, system, and method would be free from many forms of unwanted removal, would not rely on a power source within the portable identifier, and would be capable of storing a relatively large amount of data compared to conventional devices.

### SUMMARY OF THE DISCLOSURE

Embodiments of the present invention have been developed in response to the present state of the art, and in particular, in response to the problems and needs in the art that have not yet been fully solved by currently available identification and tracking systems. Accordingly, embodiments of the present invention have been developed to provide an apparatus, system, and method for identification and tracking that overcome many or all of the above-discussed shortcomings in the art.

In one embodiment, the apparatus includes a carrier medium and an identification code. The carrier medium may be semi-permanently disposed on an application surface of a target subject. The target subject may be a human or an animal. The application surface is substantially smooth and durable. The identification code is disposed on the carrier medium and includes an encoded identifier of identification information that corresponds to the target subject. The described apparatus, system, and method advantageously provide better identification and tracking of identification information for the target subject.

In one embodiment, the system includes an identification code, an identification code scanner, and a data access module. The identification code scanner is configured to scan the identification code. The data access module is configured to receive the identification code from the identification code scanner and to access the target data corresponding to the identification code.

The method in the disclosed embodiments substantially includes the steps necessary to carry out the functions presented above with respect to the operation of the described apparatus and system. In one embodiment, the method includes removing the carrier medium from an application layer, the carrier medium having an identification code disposed thereon, and disposing the carrier medium semi-permanently on an application surface of the target subject.

More detailed embodiments, features, and advantages of the apparatus, system, and method are described below and evident from the claims. Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the various embodiments of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating one embodiment of an identification system;

FIG. 2 is a schematic diagram illustrating one embodiment of an identification code;

FIG. 3 is a schematic diagram illustrating a top view of one embodiment of a carrier medium with an identification code;

FIG. 4 is a schematic diagram illustrating a side view of one embodiment of the carrier medium with the identification code of FIG. 3;

FIG. 5 is a schematic diagram illustrating another side view of one embodiment of the carrier medium with the identification code of FIG. 3;

FIG. 6 is a schematic diagram illustrating a top view of one embodiment of an application medium with an identification code;

FIG. 7 is a schematic diagram illustrating a side view of one embodiment of the application medium with the identification code of FIG. 6;

FIG. 8 is a schematic diagram illustrating another side view of one embodiment of the application medium with the identification code of FIG. 6;

FIG. 9 is a schematic diagram illustrating an exploded side view of one embodiment of an application system;

FIG. 10 is a schematic diagram illustrating an exploded front view of the application system of FIG. 9;

FIG. 11 is a schematic diagram illustrating a top view of one embodiment of an identification code and a transparent carrier medium applied to a fingernail;

FIG. 12 is a schematic diagram illustrating an exploded side view of another embodiment of an application system;

FIG. 13 is a schematic diagram illustrating an exploded front view of the application system of FIG. 12;

FIG. 14 is a schematic diagram illustrating a top view of one embodiment of an identification code and a non-transparent carrier medium applied to a fingernail;

FIG. 15 is a schematic diagram illustrating one embodiment of a modified identification code;

FIG. 16 is a schematic diagram illustrating a front view of one embodiment of an application system using the modified identification code of FIG. 15;

FIG. 17 is a schematic diagram illustrating an exploded perspective view of another embodiment of an application system;

FIG. 18 is a schematic diagram illustrating another perspective view of an application system;

FIG. 19 is a schematic block diagram illustrating another embodiment of an identification system;

FIG. 20 is a schematic diagram illustrating a top view of one embodiment of a kiss cut of an identification code;

FIG. 21 is a schematic diagram illustrating a sectional side view of one embodiment of a kiss cut of an identification code; and

FIGS. 22a through 22d are a schematic flow chart diagram illustrating one embodiment of an identification method.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as materials, structures, processes, and so forth, to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

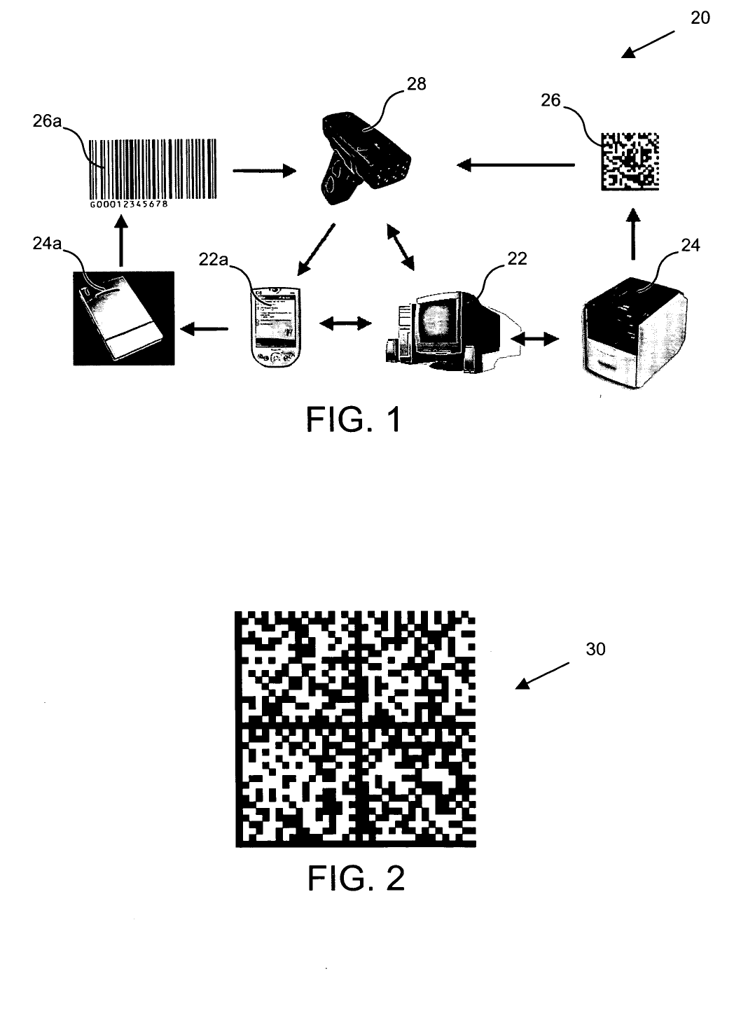

FIG. 1 depicts an identification system 20 for identifying and tracking a target subject such as a person or an animal. In particular, in one embodiment, the identification system 20 may be employed to identify and track patients in a hospital or other medical environment. Alternatively, the identification system 20 may be employed to identify and track animals within a designated area, such as cattle on a ranch or in a zoo. In further embodiments, the illustrated identification system 20 may be employed in other industries and applications where tracking humans or animals may be convenient or necessary, including amusement parks, convention centers, airline ticketing, and so forth.

The illustrated identification system 20 includes a computer system 22, an identification code applicator 24, an identification code 26, and an identification code scanner 28. Additionally, the identification system 20 includes software (not shown) that may be stored on individual system components, such as the computer system 22, identification code applicator 24 and/or identification code scanner 28, and configured to carry out one or more processes associated with the identification system 20.

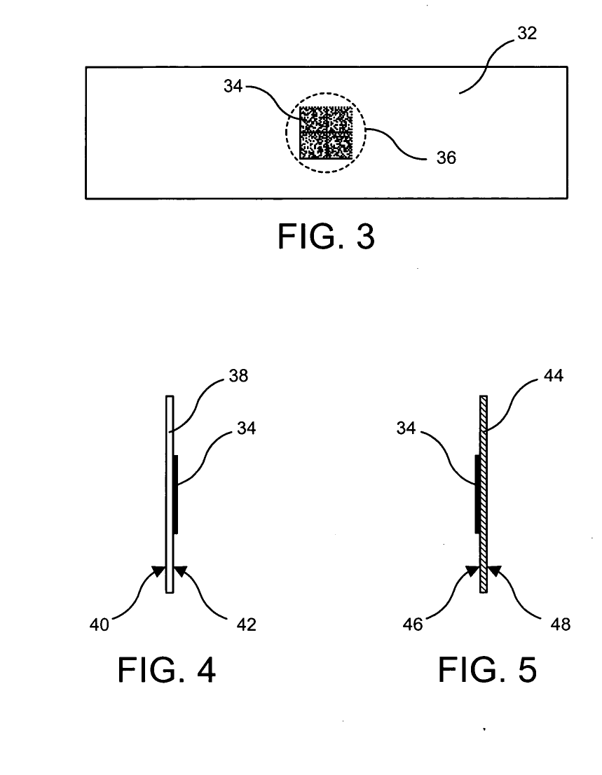

The computer system 22 is configured to store data corresponding to a target subject. In one embodiment, the computer system 22 may store medical records and patient records that correspond to the identification code 26. In further embodiments, the computer system 22 may store schedules, financial records, or other records that may correspond to a target subject. The computer system 22 communicates with the identification code applicator 24 to apply the identification code 26 to a carrier medium (refer to FIG. 3). In one embodiment, the identification code applicator 24 may be configured to encode the data in a particular identification code format, as discussed below. Alternatively, the computer system 22 may encode the data.

In one embodiment, the identification code scanner 28 is configured to read and decode the identification code 26 and convert the identification code 26 into intelligible information that may be conveyed to a person. The identification code scanner 28 may convey information to a user in the form of printed text or graphics, audible codes or voice, or any other intelligible format. In a further embodiment, the identification code scanner 28 is configured to communicate digital signals to the computer system 22 in order to transfer a digital representation of the identification code 26 to the computer system 22 or to receive data corresponding to the identification code 26 from the computer system 22. For example, the identification code scanner 28 may communicate with the computer system 22 via wireless or hardwired communications channels, including Ethernet, wireless, peer-to-peer, ad-hoc, fiber, and so forth.

The identification code scanner 28 or computer system 22 may be further configured to require an authorization code, such as a patient or health provider code, in order to scan or otherwise access the information encoded in the identification code 26. Additionally, the identification code scanner 28 may be configured to initiate an alarm or lock out certain functions if, for example, blood or medicine, which also may be scanned and identified, does not correspond to an identified patient. Similarly, the computer system 22 or identification code scanner 28 may track which patients have been visited at certain times and sound an alert if a specific patient has not been visited within a specified time frame.

FIG. 1 also illustrates additional components of the identification system 20. Namely, the identification system 20 may include a portable electronic device 22a, such as a personal digital assistant (PDA), and a portable printer 24a. The portable electronic device 22a may be configured to communicate with the identification code scanner 28, the computer system 22, and the portable printer 24a. In further embodiments, the portable electronic device 22a may also communicate bi-directionally with these and other system components. The portable printer 24a may be configured to print identification codes 26, as described herein, as well as other codes that may or may not be scannable by the identification code scanner 28. For example, the portable printer may print conventional bar codes on identification tags that may also include identification codes 26. In a further embodiment of the system 20, the functionality of the several components may be combined in one or more devices, for example, a PDA/scanner, a PDA/printer, a scanner/printer, or a PDA/scanner/printer.

FIG. 2 depicts one embodiment of an identification code 30 that is substantially similar to the identification code 26 of FIG. 1. In one embodiment, the identification code 30 is configured to store patient information, including some or all of the following: name, age, birth date, patient visit record number, patient medical record number, blood type, current medications, allergic reactions, and so forth. The illustrated identification code 30 is a matrix identification code that is a visual representation of data that employs Reed-Solomon error correction and data redundancy. The data represented in any identification code, barcode, or other data code format may be encrypted and employ data compression. A matrix identification code is currently scalable between approximately 1 millimeter square to 35.5 centimeters square. The scalability of the matrix identification code is dependent on the fidelity of the marking device, such as a printer, and the optics of the scanning device, such as the identification code scanner 28.

In one embodiment, the identification code scanner 28 is a charge coupled device (CCD) or Complementary Metal Oxide Semiconductor (CMOS), similar to a digital video camera, that can read the matrix identification code 30 from various distances. Some identification code scanners 28 may be configured to read the identification code 30 at virtually zero distance when the identification code scanner 28 is in physical contact with the identification code 30. Other identification code scanners 28 may be configured to read the identification code 30 from a range of distance such as 3 to 20 inches, or another distance that is closer to or farther from the identification code 30. Additionally, the identification code 30 may be one dimensional, such as a conventional UPC bar code, or two dimensional, such as the Data Matrix, MaxiCode, PDF, or QR Code bar codes, or three dimensional barcodes. In one embodiment, the matrix identification code 30 is employed to take advantage of its scalability, insensitivity to damage, error correction, compactness, low error rates, and other desirable attributes.

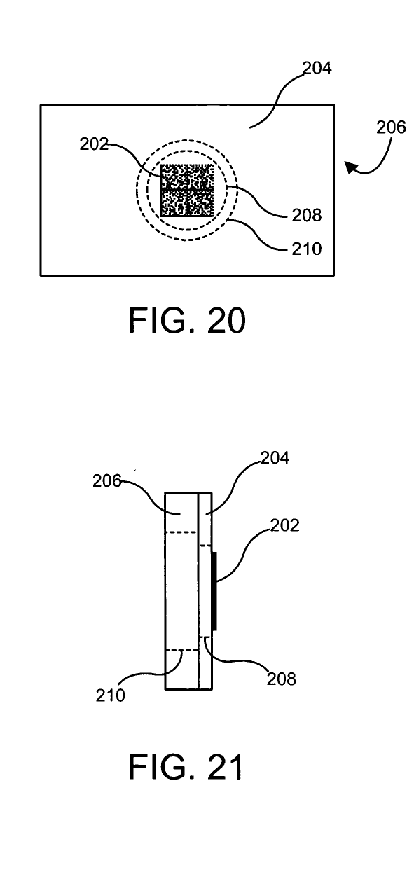

FIG. 3 depicts one embodiment of a carrier medium 32 with an identification code 34 applied to the carrier medium 32. The identification code 34 of FIG. 3 is substantially similar to the identification code 30 of FIG. 2. In one embodiment, the carrier medium 32 is an abrasion resistant laminate, such as polyethelene (PET). The identification code 34 is applied to the carrier medium 32 within an area that may be defined by one or more separation guidelines 36. The separation guideline 36 also may be used in removing the section of the carrier medium 32 to which the identification code 34 is applied from the rest of the carrier medium 32. The section may be removed by cutting, die cutting, punching, or other known removal means. In one embodiment, kiss-cutting may be employed to cut through only a given number of the layers disposed on or near the carrier medium 32. One example of kiss-cutting is described in more detail with reference to FIG. 20. The carrier medium 32 may be composed of one or more layers, including paper, plastic, metal foil, adhesives, and so forth.

The identification code 34 may be applied to the carrier medium 32 using a variety of methods, including printing, laser marking, adhesion, engraving, or another similar marking technique or combination of marking techniques. In one embodiment, the identification code applicator 24 may be configured to apply the identification code 34 to the carrier medium 32 by printing the identification code 34 on the carrier medium 32. For example, the identification code applicator 24 may be a conventional inkjet, laser, or thermal printer, such as a Brothers™ label printer. In a further embodiment, the identification code applicator 24 may be configured to punch or cut the appropriate section from the carrier medium 32 as delineated by the separation guidelines 36.

FIG. 4 depicts a side view of an identification code 34 applied to a carrier medium 38. The illustrated carrier medium 38 defines an exposed face 40 and a bond face 42. In one embodiment, the carrier medium 38 is transparent and the identification code is applied in reverse to the bond face 42 of the transparent carrier medium 38. In this way, when the identification code 34 is adhered to a target subject, such as a medical patient, the identification code 34 may be protected from wear by the carrier medium 38. Alternately, the identification code 34 may be applied to the exposed face 40 of the transparent carrier medium 38. When applied to the exposed face 40 in this manner, the identification code 34 is not applied in reverse.

FIG. 5 depicts a side view of a further embodiment of an identification code 34 applied to a transparent or non-transparent carrier medium 44. In the illustrated embodiment, the identification code 34 is applied to the exposed face 46 of the carrier medium 44 rather than to the bond face 48. If the identification code 34 were applied to the bond face 48 of a non-transparent carrier medium 44, the identification code 34 would likely be difficult or impossible to scan and/or see.

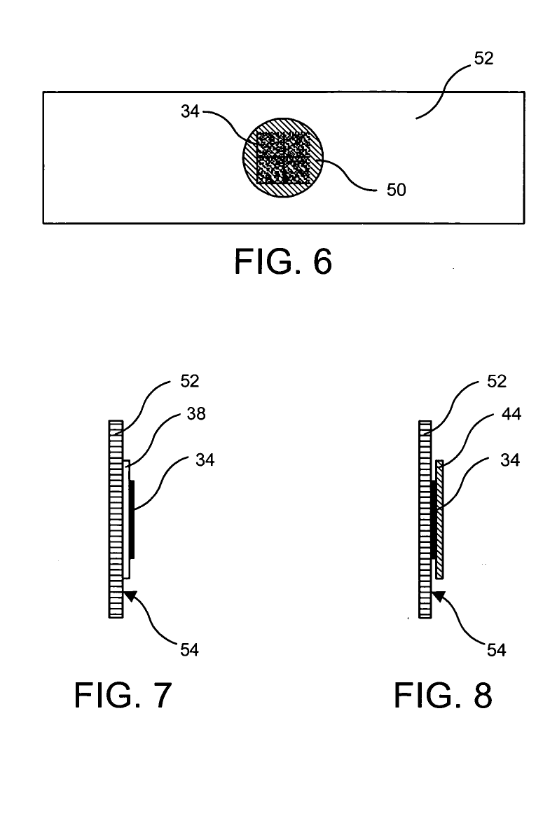

FIG. 6 depicts one embodiment of an application medium 52 with an identification code 34. The application medium 52, in one embodiment, is configured to assist a user in applying the identification code 34 to an intended surface, such as a fingernail or another durable and smooth surface. The carrier medium 50, including the applied identification code 34, is temporarily applied to the application medium 52, such as with a mild adhesive or substantially non-stick application medium 52. In one embodiment, the application medium 52 may be a piece of tape having one sticky face. The application medium 52 may comprise a transparent or semi-transparent material that is flexible to allow a user to see the placement of the identification code 34 as well as facilitate application of the identification code 34 to a flat or non-flat surface. In one embodiment, the identification code applicator 24 may be configured to apply carrier medium 50 to the application layer 52. Furthermore, the identification code application 24 may be configured to punch or cut the carrier medium 50 while applied to the application medium 52.

FIG. 7 depicts a side view of one embodiment of a transparent carrier medium 38 applied to the application medium 52. As discussed with reference to FIG. 4, the identification code 34 may be applied to the bond face 42 of the transparent carrier medium 38. By applying the exposed face 40 of the transparent carrier medium 38 to the bond face 54 of the application medium 52, the identification code 34 may be visible and protected by the transparent carrier medium 38 once it is applied to, for example, a fingernail.

FIG. 8 depicts a side view of one embodiment a non-transparent carrier medium 44 applied to the application medium 52. As discussed with reference to FIG. 5, the identification code 34 may be applied to the exposed face 46 of the non-transparent carrier medium 44. By applying the exposed face 46 of the non-transparent carrier medium 44 to the bond face 54 of the application medium 52, the identification code 34 may be visible once it is applied to the intended surface, such as a fingernail or toenail.

Alternatively, the carrier medium 50 may be disposed on the application medium 52 to facilitate a “peel-and-stick” process where the carrier medium 50 may be peeled from the application medium 52. Once removed, a user may stick the carrier medium 50 on a target subject.

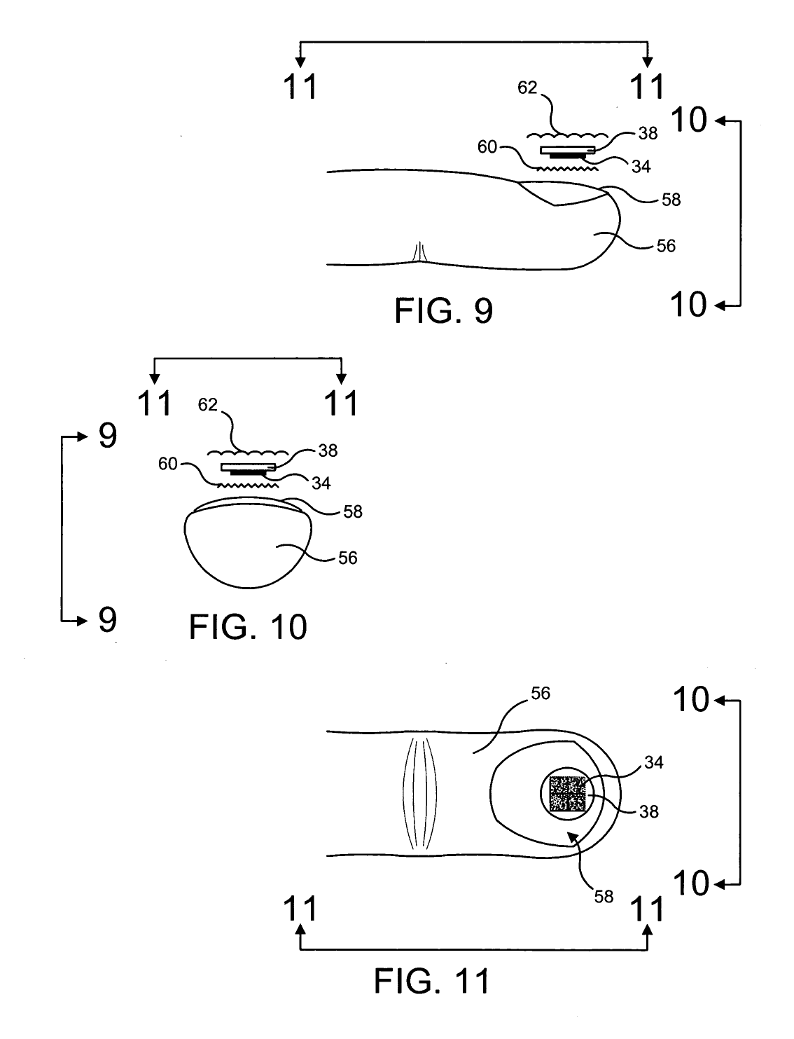

FIG. 9 depicts an exploded view of an identification code 34 applied to a human finger 56. Specifically, the identification code 34 is applied to the exposed surface of the fingernail 58. As discussed above, the identification code 34 may alternately be applied to another durable and smooth surface of a human or animal, such as a toenail, shell, horn, and so forth. In one embodiment, the identification code 34 is applied to a fingernail 58 or toenail of sufficient surface area to accommodate the identification code 34. Alternately, an identification code 34 may be produced, such as through scaling, according to the size constraints of a particular application surface.

In FIG. 9, the illustrated identification code 34 is applied to a transparent carrier medium 38, as discussed with reference to FIG. 4. Although not shown in FIG. 9, the application medium 52 of FIGS. 6 and 7 may be used to facilitate application of the identification code 34 to the illustrated fingernail 58. Once the identification code 34 is disposed on the fingernail 58, the application medium 52 may be removed and discarded. Alternatively, the identification code 34 may be removed from the application medium 52 prior to disposal on the application surface.

In one embodiment, the application surface, such as the fingernail 58, is cleaned prior to applying the identification code 34. To clean the fingernail 58, a user may wipe the fingernail 58 with water, alcohol, or another suitable nail cleaner (not shown) to remove oils or other contaminants that may impede proper application. Additionally, the user may fill any discontinuities in the surface of the fingernail 58, such as with a fingernail polish (not shown), to ensure a substantially smooth application surface. Alternately, the user may file the face of the fingernail 58 to prepare a smooth surface for application of the identification code 34.

Once the fingernail 58 is prepared, in one embodiment allowing the surface of the fingernail 58 to dry, the user may apply a layer of bonding adhesive 60 to the fingernail 58. The bonding adhesive 60, in one embodiment, may comprise a cyanoacrylate based composition, such as a glue, resin, or gel. Alternately, the bonding adhesive 60 may comprise another semi-permanent or substantially permanent adhesive. Furthermore, the bonding adhesive 60 may be applied to the bond face 42 of the transparent carrier medium 38 in addition to, or instead of, being applied to the fingernail 58. In one embodiment, the identification code applicator 24 applies the bonding adhesive 60 to the bond face of the transparent carrier medium 38.

The carrier medium 38 is subsequently adhered to the fingernail 58 by the bonding adhesive 60. The transparent carrier medium 38 may be temporarily disposed on the application medium 52 as shown in FIG. 7 prior to application of the carrier medium 38 to the fingernail 58. The application medium 52 may facilitate application of the carrier medium 38 to the fingernail 58 by allowing a user to properly position and orient the identification code 34 on the fingernail 58. As discussed above, the application medium 52 may be transparent or otherwise non-opaque so that the user may see the spatial relation between the identification code 34 and the fingernail 58 during the application process. In one embodiment, the application medium 52 is of a shape and size that is conducive to single-handed operation, such as a small, semi-rigid, yet flexible piece of plastic. Alternatively, the application medium 525 is of a shape and size that facilitates a peel-and-stick operation.

A protective coating 62 may be applied on top of the carrier medium 38 to further protect the identification code 34 from unnecessary exposure, wear, and damage. In certain embodiments, the protective coating 62 may be a cross-linked polymer activated by mixing two parts, such as an epoxy, a one part coating activated by evaporation, such as nail polish, or a one part coating activated by light, such as UV activated gels, spray-on nail glue, brush-on nail glue, or adhesives. In certain embodiments, the protective coating 62 may include one or more of the following compositions: ethyl cyanoacralate, cyanoacralate esters, poly methyl methacrylate, and so forth.

FIG. 10 depicts another exploded view of the identification code 34 applied to a fingernail 58, as discussed with reference to FIG. 9. FIG. 10 illustrates the finger 56, fingernail 58, bonding adhesive 60, transparent carrier medium 38, identification code 34, and protective coating 62. FIG. 11 depicts a top view of the identification code 34 and transparent carrier medium 38, in one embodiment, applied to the fingernail 58.

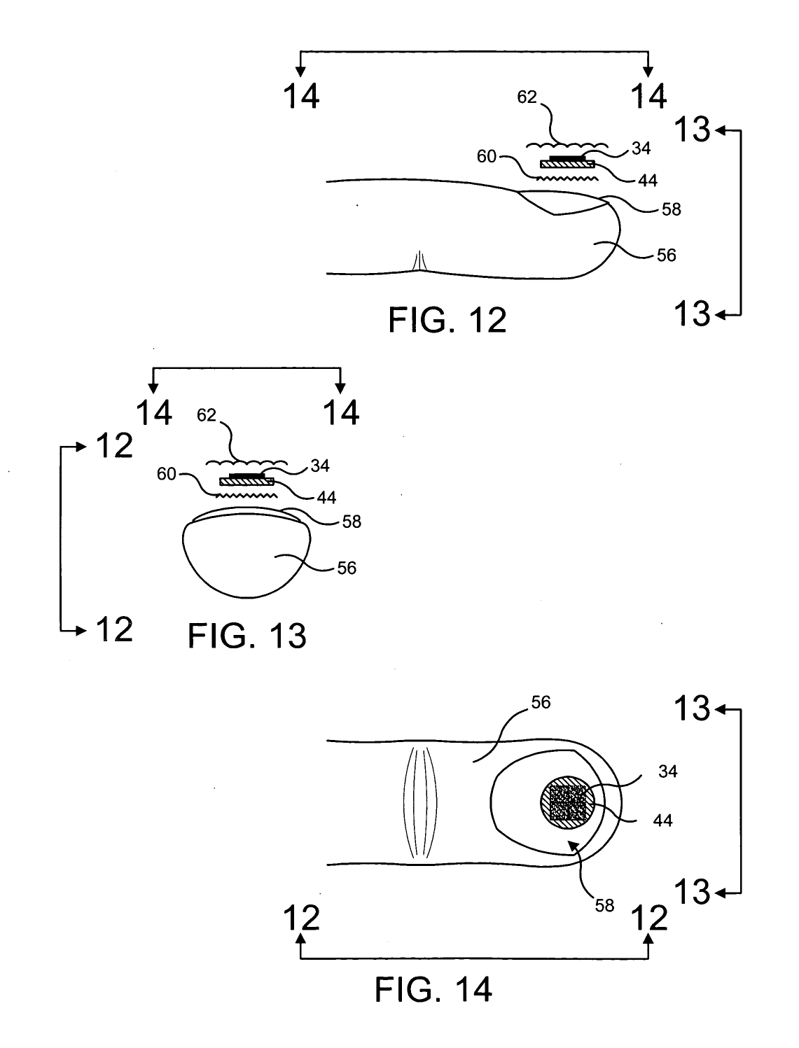

FIG. 12 depicts an exploded view of another embodiment of an identification code 34 applied to a human finger 56. In the illustrated embodiment, the identification code 34 is applied to the exposed face 46 of a transparent or non-transparent carrier medium 44. The bond face 48 of the carrier medium 44 is then adhered to the fingernail 58 by the bonding adhesive 60, allowing the identification code 34 to be visibly exposed. A protective coating 62 may be applied to protect the identification code 34, as described with reference to FIG. 9. The application medium 52 of FIGS. 6 and 8 may be employed to facilitate application of the identification code 34 and non-transparent carrier medium 44 to the fingernail 44.

FIG. 13 depicts a another exploded view of the identification code 34 applied to a fingernail 58, as discussed with reference to FIG. 11. FIG. 12 illustrates the finger 56, fingernail 58, bonding adhesive 60, non-transparent carrier medium 44, identification code 34, and protective coating 62. FIG. 14 depicts a top view of the identification code 34 and transparent or non-transparent carrier medium 44, in one embodiment, applied to the fingernail 58.

The identification code 34 and carrier medium 32 may be disposed on the application surface (e.g., fingernail 58 or other surface) for a substantial amount of time, depending on the wear and handling of the identification code 34, as well as the type of bonding adhesive 60 or other application method used. In fact, the length of time that the identification code 34 is intended to remain adhered to a fingernail 58, for example, may determine the type of bonding adhesive 60 or other application method employed. In order to remove the identification code 34 from the fingernail 58 prior to the useful life of the carrier medium 32 and bonding adhesive 60, a user may employ one of a variety of means. For example, a user may use a solvent or other chemical agent to destroy the adhesion between the carrier medium 32 and the bonding adhesive 60. Alternately, a user may file or otherwise grind the protective coating 62, if any, carrier medium 32, identification code 34, and bonding adhesive 60 off of the surface of the fingernail 58. In a further embodiment, the identification code 34 may remain on the fingernail 58 until the fingernail 58 grows out and is cut by a user. Other equivalent means and methods may also be employed to remove the various foreign substances and mediums applied to the fingernail 58.

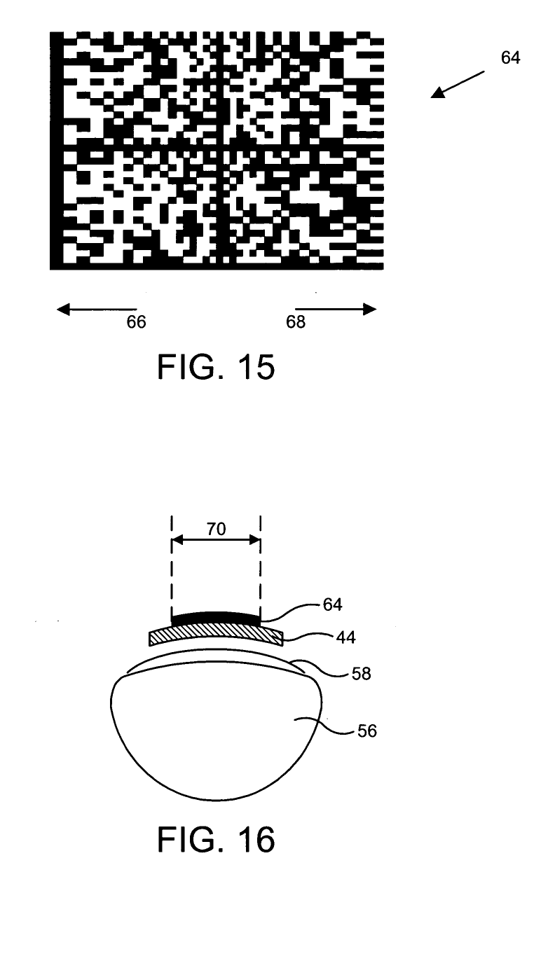

FIG. 15 depicts one embodiment of a modified identification code 64 that may be employed on a non-flat surface. The illustrated modified identification code 64 is distorted in a non-linear fashion in the direction of the arrows 66, 68. In particular, the modified identification code 64 is the same as the identification code 30 of FIG. 2, except that the horizontal width of each pixel varies depending on the location within the modified identification code 64. In other words, the pixels toward either vertical edge of the matrix are stretched horizontally, which may account for the curvature or other distortion of a potential application surface. In a further embodiment, a modified identification code 64 may be applied to a carrier medium 32 that is also distorted, such as a piece of foil having a natural or manufactured curvature.

FIG. 16 depicts one embodiment of a modified identification code 64 in relation to a fingernail 58. For clarity, FIG. 16 does not illustrate any adhesive bonding 60, protective coating 62, or other layers, although each maybe used independently or jointly to apply and protect the modified identification code 64 to the fingernail 58. The modified identification code 64 is applied to the curved surface of the fingernail 58, but is configured to be read by a scanner that also may read a non-distorted identification code. In the depicted embodiment, the modified identification code 64 is designed to compensate for the curvature of the application surface so that, when projected through a substantially flat scanning plane 70, the modified identification code 34 appears to be unmodified.

Although the illustrated fingernail 58 is depicted to portray the curvature in only one direction, the modified identification code 64 may be designed to compensate for multi-dimensional curvatures, bends, aberrations, or other discontinuities in the application surface. Alternatively, the optics of the identification code scanner 28 may be altered to compensate for application surface distortions. In a further embodiment, the software that processes the scanned images from the identification code scanner 28 may recognize and account for identification code or application surface distortions affecting an otherwise unmodified identification code 34.

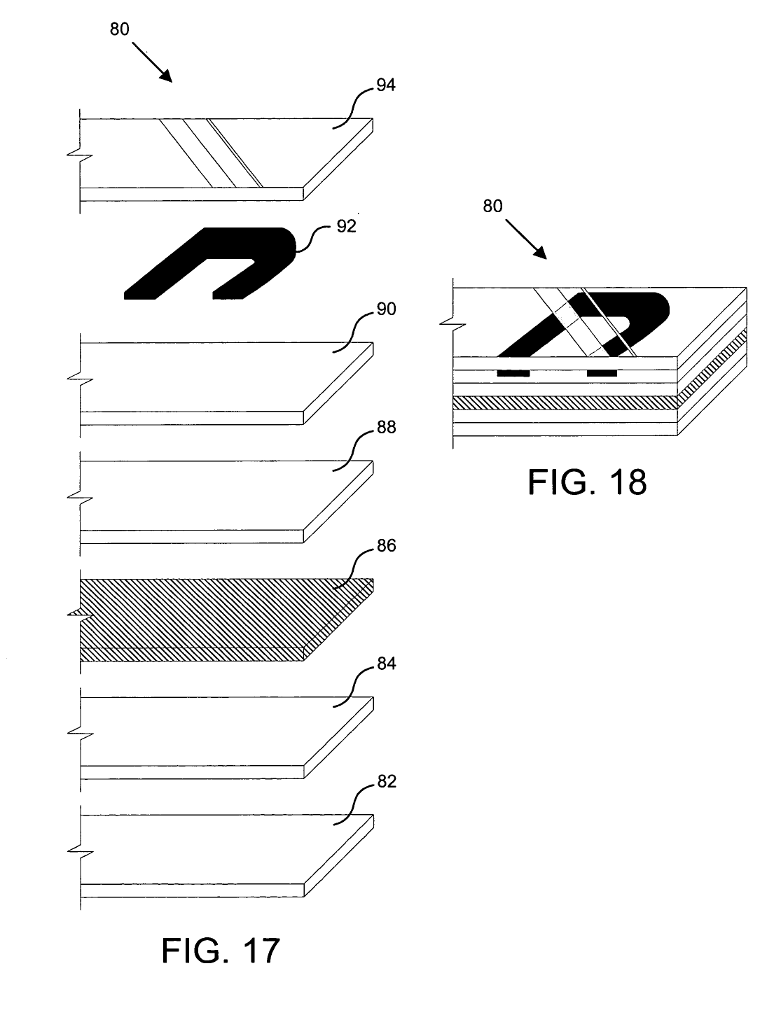

FIG. 17 depicts another embodiment of an application system 80 that may be employed. The illustrated application system 80 includes an application medium 82, a bonding adhesive 84, a colorant 86, a base film 88, a base film adhesive 90, an identification code 92, and a carrier medium 94. In one embodiment, each of these layers is substantially similar to the corresponding layers described in detail above. Furthermore, the colorant 86 may be disposed on or integrated within the base film 88. The carrier medium 94, in on embodiment, may be transparent. Alternatively, the identification code 92 may be disposed on the opposite side of the carrier medium 94, which may be transparent or non-transparent, and a protective layer (not shown) may be disposed on the identification code. The bonding adhesive 84 and base film adhesive 90 may be the same or different compositions. In one embodiment, the bonding adhesive 84 and the base film adhesive 90 may be acrylic based compositions. Alternatively, the colorant 86 may be omitted and the base film 88 may be transparent.

FIG. 18 depicts one embodiment of an assembled application system 80. In one embodiment, the application medium 82 may be peeled away from the other layers within the application system 80 and the bonding adhesive 84 may facilitate disposal on the application surface, such as a fingernail 58.

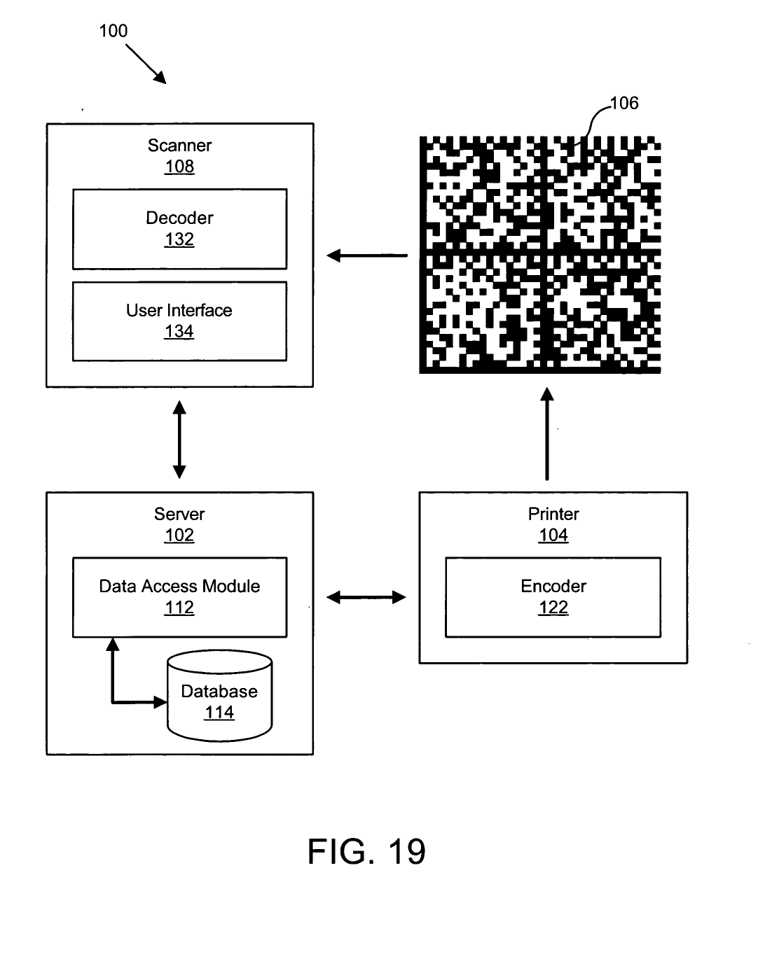

FIG. 19 depicts another embodiment of an identification system 100 that is similar to the identification system 20 shown in FIG. 1. The illustrated identification system 100 includes a server 102, a printer 104, a matrix identification code 106, and a scanner 106, which are specific examples of possible components within the identification system 100.

The server 102 includes a data access module 112 and a database 114. The data access module is configured, in one embodiment, to access data, such as target data, stored on the database 114. For example, the data access module 112 may read data from the database that corresponds to a given identification code 106. The database 114 is representative of any electronic storage device or data structure that is capable of storing electronic data.

The printer 104 is configured to print the identification code 106 on a carrier medium 32, as described above. In one embodiment, the printer 104 may include an encoder 122 that encodes the identification code 106 in a matrix, barcode, or other identification code format. Alternatively, the encoder 122 may reside in the server 102.

The scanner 108 is configured, in one embodiment, to read and decode the identification code 106. The illustrated scanner 108 includes a decoder 122 and a user interface 124. The decoder 122 is configured to decode the identification code upon scanning, for example. Alternatively, the decoder may be located in the server 102. The user interface may include one or more user input or output devices, including, but not limited to, a button, a microphone, a speaker, a light emitting diode (LED) indicator, a display screen, and so forth. In one embodiment, the scanner 108 may particularly include separate LED indicators and beep sequences to notify a user of one type of identification code 106 versus another type of identification code 106.

FIG. 20 depicts on embodiment of an identification code 202 disposed on a carrier medium 204 that, in turn, is disposed on an application medium 206 (behind the carrier medium 204). The carrier medium 204 is kiss-cut at a first location 208 (shown dashed) near the identification medium. The application medium 208 is kiss-cut at a second location 210 (shown dashed) that is slightly offset from the first location 208. Although the offset may allow for easier removal of the carrier medium 204 from the application medium 206, the application medium 206 may be kiss-cut at a second location 210 that corresponds to, is greater than, or is less than the first location 208.

FIG. 21 depicts a side sectional view of the carrier medium 204 and application medium 206. In particular, FIG. 21 illustrates the first and second kiss-cut locations 208, 210, showing that the each kiss-cut only cuts through a specified number of layers, but not through the other layers. For example, the kiss-cut at the first location 208 only cuts through the carrier medium 204 and not through the application medium 206. Likewise the kiss-cut at the second location 210 only cuts through the application medium 206 and not through the carrier medium 204. In one embodiment, both the first and second kiss-cuts terminate at approximately the interface between the carrier medium 204 and the application medium 206.

In a further embodiment, the identification code 30 of FIG. 2 maybe applied directly to a smooth and durable surface, such as a fingernail, by printing, etching, or otherwise marking the surface. For example, an identification code 30 may be etched onto the fingernail of a patient using an appropriate laser etching applicator 24. Likewise, the etched identification code 30 may be scanned using an appropriate etching scanner 28 that is configured to scan an etched identification code 30 instead of, or in addition to, a printed identification code 30. Further embodiments may be configured to employ other direct marking techniques.

With further reference to FIGS. 20 and 21, the carrier medium 204 may include a water soluble material similar to a temporary tattoo, in one embodiment. For example, the identification code 202 may be disposed on a non-bonding surface of the carrier medium 204 by an inkjet printer. The carrier medium 204 may be semi-transparent and may be removably disposed on the application medium 206, such as a paper backing. In one embodiment, the carrier medium 204 and application medium 206 may be kiss-cut as described above. In certain embodiment, the kiss-cutting may occur at the point of use or beforehand, such as during production. Furthermore, the kiss-cutting may occur either before or after the identification code 202 is disposed on the carrier medium 204. After the identification code 202 is disposed on the target subject, the identification code 202 may be protected by a protective coating, as described above.

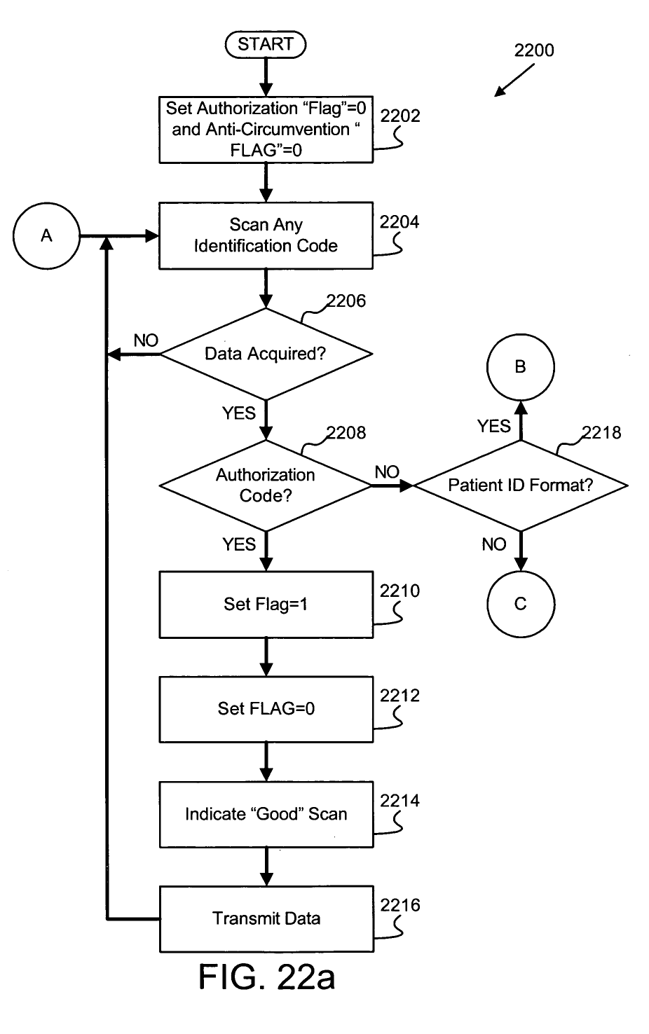

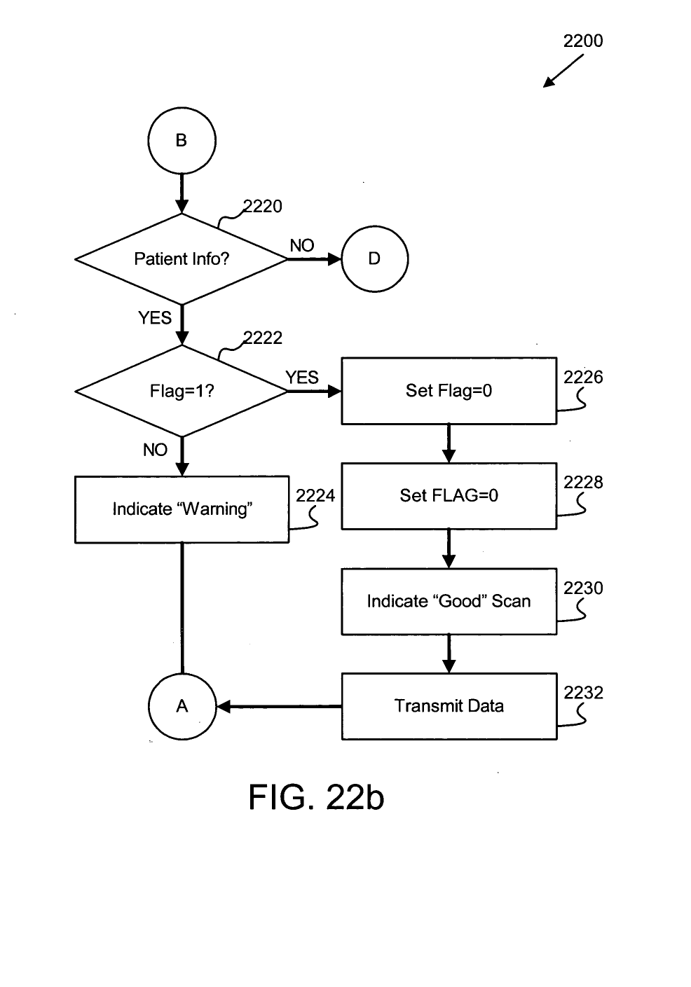

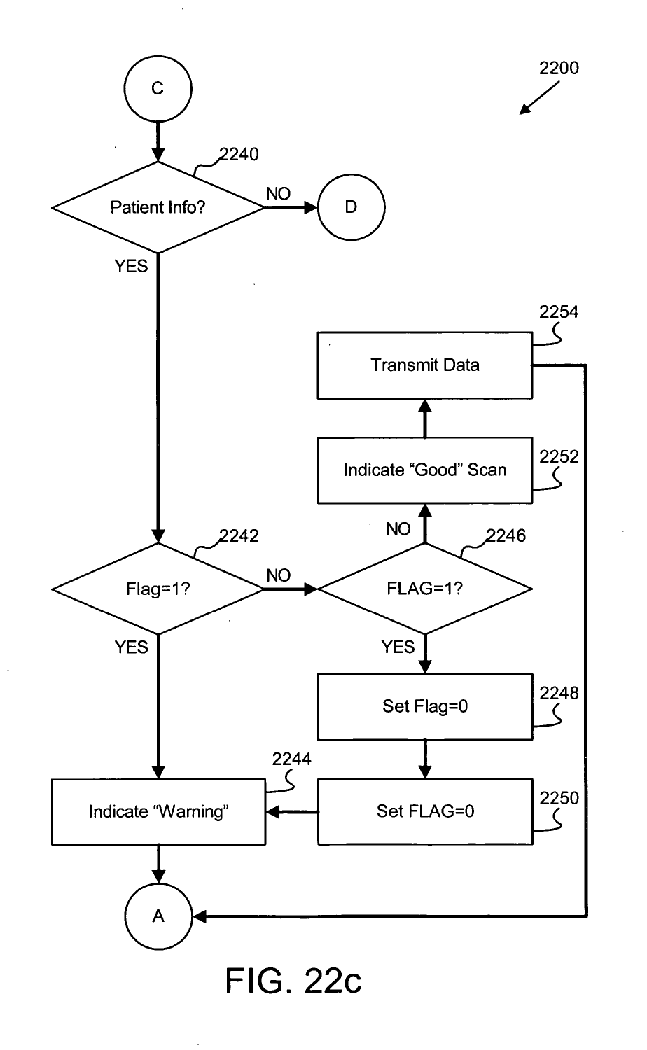

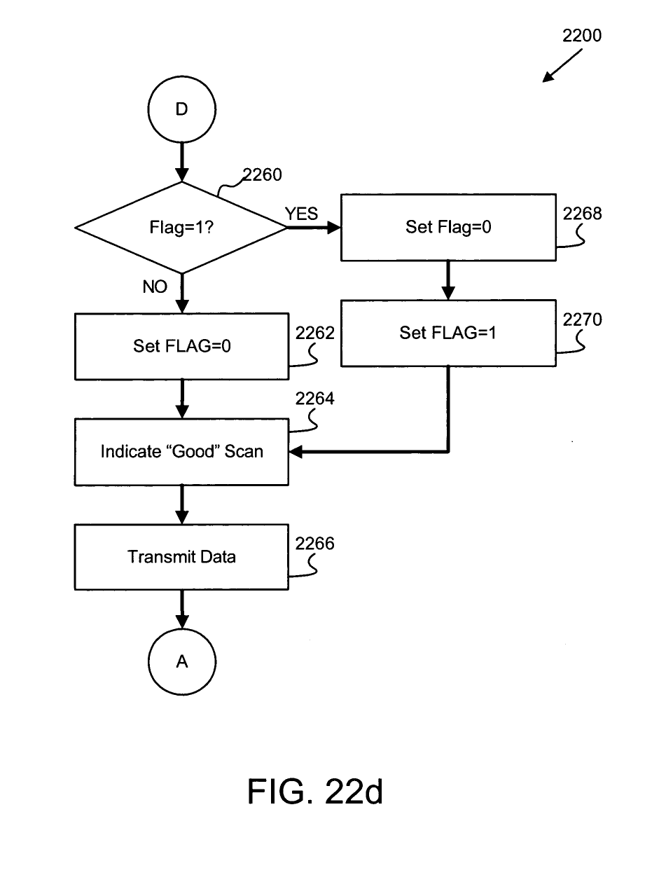

FIG. 22 depicts one embodiment of an identification method 2200 that may be implemented in conjunction with the identification system 20 of FIG. 1. Because an identification code scanner 28 may be used to scan different types of identification codes, it may be advantageous to distinguish between a patient identification code 30 disposed on a patient compared to another type of identification code, for example, in the medical records of the patient or on a medicine container. The illustrated identification method 2200 allows positive distinction between patient identification codes 30 and other types of identification codes. Such a positive distinction between codes may allow enhanced patient care by requiring positive identification of patients for medical procedures or administration of medications. Although the identification method 2200 is discussed in terms of hospitals and patient identification, the identification method 2200 is also application to many other types of identification environments where it may be advantageous to distinguish among various types of identification codes.

Two distinguishing features of a patient identification code 30 may be its format and/or content. In one embodiment, the format of the patient identification code 30 may be unique. In a further embodiment, the content or information represented by the patient identification code 30 maybe unique. In one embodiment, the identification method 2200 may use “flags,” such as bits within a memory device, to indicate the status of an input. Although the identification method employs flags, other types of status indicators may be employed to compliment or replace the use of flags. One flag is referred to as an authorization flag (“Flag”), which indicates if an authorization code is scanned. For example, a healthcare worker may scan a healthcare worker identification code to indicate which healthcare worker is administering a medicine, for example. Another flag is referred to as an anti-circumvention flag (“FLAG”), which prevents circumvention of the authorization flag, as described below.

The illustrated identification method 2200 begins by setting 2202 the authorization Flag and anti-circumvention FLAG to null (zero). Setting a flag to null also may be referred to as clearing the flag. The identification code scanner 28 is then used to scan 2204 any identification code. If the scanner 28 determines 2206 that no data was acquired during the scan 2204, then the scanner 28 may proceed to scan 2204 another identification code. Alternatively, the scanner 28 may enter a ready or standby status from which the scanner 28 may be readily activated to scan 2204 another identification code.

If the scanner 28 determines 2206 that data was acquired, the scanner 28 then determines 2208 if the data includes an authorization code. The authorization code may be characterized by a particular code format and/or content. In one embodiment, the authorization code may be a healthcare worker's identification code, as opposed to a patient identification code 30. If the acquired data includes an authorization code, the scanner 28 sets 2210 the authorization Flag to one and sets 2212 the anti-circumvention FLAG to zero. The scanner 28 then may indicate 2214 to the user that the scan was “good,” or successful, and transmit 2216 any data necessary to another component within the identification system 20. The scanner 28 may then scan 2204 another identification code.

If the scanner 28 determines 2208 that the data acquired does not include an authorization code, the scanner may determine 2218 if the scanned identification code has the same format as a patient identification code 30. As described above, the patient identification code 30 may have a unique format from other types of identification codes. FIG. 22b depicts various operations of the identification method 2200 that may occur if the scanned identification code has the same format. FIG. 22c depicts various operations of the identification method 2200 that may occur if the scanned identification code does not have the same format as a patient identification code 30.

If the format is the same, the scanner 28 then determines 2220 if the acquired data includes patient information and, if so, determines 2222 if the authorization Flag is set to one. If the authorization Flag is not set to one, then the scanner 28 indicates 2224 a “warning,” or invalid scan, to the user. However, if the authorization Flag is set to one, the scanner clears 2226 the authorization Flag, clears 2228 the anti-circumvention FLAG, indicates 2230 a “good” scan to the user, and may transmit 2232 within the identification system 20. If the scanner 28 determines 2220 that the acquired data does not include patient information, the identification method 2200 proceeds with operations shown in FIG. 22d.

If the format of the scanned identification code is not the same as the unique patient identification code, the scanner 28 determines 2240 if the acquired data includes patient information, similar to the determination 2220. If the scanner 28 determines 2240 that the identification code includes patient information, then the scanner 28 determines 2242 if the authorization Flag is set to one and, if so, indicates 2244 a “warning” to the user. Otherwise, if the authorization Flag is not set to one, the scanner 28 may determine 2246 if the anti-circumvention FLAG is set to one. If the anti-circumvention FLAG is set to one, the scanner 28 clears 2248 the authorization Flag and clears 2250 the anti-circumvention FLAG. If the anti-circumvention FLAG is not set to one, the scanner 28 indicates 2252 a “good” scan and may transmit 2254 data within the identification system 20. If the scanner 28 determines 2220 that the acquired data does not include patient information, the identification method 2200 proceeds with operations shown in FIG. 22d.

FIG. 22d depicts operations of the identification method 2200 that maybe implemented when the scanned identification code does not include patient identification, regardless of the format of the scanned identification code. Once the scanner determines 2220, 2240 that the scanned identification code does not include patient identification, the scanner 28 determines 2260 if the authorization Flag is set to one. If the authorization Flag is not set to one, the scanner 28 sets 2262 the anti-circumvention FLAG to zero, indicates 2264 a “good” scan, and may transmit 2266 any data. Otherwise, if the authorization Flag is set to one, the scanner 28 clears 2268 the authorization Flag and sets 2270 the anti-circumvention FLAG to one. The scanner 28 may then indicate 2264 a “good” scan and transmit 2266 data, as described above. After any successful (“good”) or unsuccessful (“warning”) scan, the scanner 28 may return to scan 2204 another identification code, as described above.

Table 1 below summarizes the operations that may be implemented, given certain inputs to the scanner 28, as described in the identification method 2200. Advantageously, the use of multiple flags (i.e. Flag and FLAG) prevents circumvention in the identification method 2200. In the described embodiment, the anti-circumvention FLAG may be cleared by scanning an identification code that includes an authorization code. In alternative embodiments, other operations may be implemented to clear the anti-circumvention FLAG, such as a manual “clear” button that may be depressed by the user. Furthermore, additional flags may be used to provide additional layers of protection against circumvention. The indicating schemes to indicate “good” scans and “warnings” to the user may be achieved through one or more conventional means, including indicating lights, audible beeps, prerecorded textual messages, and so forth.

TABLE 1
Inputs and Operations of Identification Method

| INPUTS | | | | | OPERATIONS | | | |
|---|---|---|---|---|---|---|---|---|
| Auth. Code | Auth. Flag | Anti-C. FLAG | Format | Info | Auth. Flag | Anti-C. FLAG | Indication | Transmit |
| Yes | X | X | X | X | 1 | 0 | Good | Yes |
| No | 0 | X | X | No | (same) | 0 | Good | Yes |
| No | 0 | 0 | No | Yes | (same) | (same) | Good | Yes |
| No | 0 | X | Yes | Yes | (same) | (same) | Warning | No |
| No | 0 | 1 | No | Yes | 0 | 0 | Warning | No |
| No | 1 | X | X | No | 0 | 1 | Good | Yes |
| No | 1 | X | No | Yes | (same) | (same) | Warning | No |
| No | 1 | X | Yes | Yes | 0 | 0 | Good | Yes |

Additionally, the need for multiple flags may be eliminated in an identification system 20 in which two-way communication exists between the identification scanner 28 and the computer system 22. For example, in one embodiment, the authorization Flag may be reset only in response to a determination by the computer system 22 that the code format is correct, the data content is correct, and the data is accepted by the user.

In one embodiment, all of the operations described above for the identification method 2200 may occur within the identification code scanner 28, through the use of electronic data memory, a processor, and so forth. Alternatively, embodiments of the identification method 2200 may occur within the identification system 20, generally, wherein different operations may be performed by one or more system components, especially the computer system 22.

The schematic flow chart diagrams described above are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In a further embodiment, the identification code 30 may be used in combination with one or more other identification techniques, including conventional barcodes, written or printed text, radio frequency identification (RFID) tags, and so forth. For example, an RFID tag could be disposed within layers of the application system 80 of FIGS. 17 and 18. In one embodiment, the identification code scanner 28 maybe configured to communicate with the RFID tag in order to read information from the RFID tag or to write information to the RFID tag. Alternatively, another read/write device may be used with the RFID tag.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus to identify a target subject, the apparatus comprising:
a carrier medium configured to be semi-permanently disposed on a substantially smooth and durable application surface of a target subject, wherein the target subject comprises one of a human and an animal; and
an identification code disposed on the carrier medium, the identification code comprising an encoded identifier of identification information corresponding to the target subject.

2. The apparatus of claim 1, wherein the carrier medium is configured to be semi-permanently disposed on a keratin surface.

3. The apparatus of claim 2, wherein the carrier medium is configured to be semi-permanently disposed on one of a fingernail and a toenail.

4. The apparatus of claim 1, wherein the identification code comprises a matrix identification code.

5. The apparatus of claim 1, wherein the identification code is scalable in at least one direction.

6. The apparatus of claim 5, wherein the identification code is scaled to correspond to a non-flat application surface.

7. The apparatus of claim 1, wherein the carrier medium comprises an abrasion-resistant laminate.

8. The apparatus of claim 1, wherein the identification code is printed in ink on a first surface of the carrier medium.

9. The apparatus of claim 8, wherein the carrier medium is transparent and the identification code is printed in reverse on the first surface of the carrier medium.

10. The apparatus of claim 1, wherein the identification code is protectively disposed between the carrier medium and the application surface of the target subject when the carrier medium is disposed on the application surface.

11. The apparatus of claim 1, wherein a carrier medium comprises a first surface and a second surface, the identification code disposed on the first surface and the second surface configured to be disposed on the application surface of the target subject.

12. The apparatus of claim 1, further comprising a base film and a base film adhesive, wherein the base film adhesive adheres the base film to the carrier medium.

13. The apparatus of claim 12, wherein the base film is at least partially opaque.

14. The apparatus of claim 12, wherein the base film is at least partially transparent.

15. The apparatus of claim 1, further comprising a bonding adhesive, wherein the carrier medium is configured to be disposed on the application surface by the bonding adhesive.

16. The apparatus of claim 15, wherein the bonding adhesive comprises at least one of cyanoacrylate, cyanoacrylate ester, and poly methyl methacrylate.

17. The apparatus of claim 15, wherein a base film is interposed between the carrier medium and the bonding adhesive.

18. The apparatus of claim 1, further comprising a protective coating configured to be disposed over the carrier medium when the carrier medium is disposed on the application surface, the protective coating to protect the identification code from exposure.

19. The apparatus of claim 1, further comprising an application medium, wherein the carrier medium is removably disposed on the application medium, the carrier medium configured to be removed from the application medium approximately prior to disposal on the application surface of the target subject.

20. The apparatus of claim 1, further comprising a radio frequency identification (RFID) tag.

21. A system to identify a target subject, the system comprising:
an identification code configured to be disposed on a target subject, the identification code comprising an encoded identifier of identification information corresponding to a target subject, wherein the target subject comprises one of a human and an animal;
an identification code scanner configured to scan the identification code; and
a data access module configured to receive the identification code from the identification code scanner and to access target data corresponding to the identification code.

22. The system of claim 21, further comprising an identification code applicator configured to dispose the identification code on a carrier medium.

23. The system of claim 22, wherein the carrier medium is disposed on a base film, the base film removably disposed on an application medium by a non-permanent adhesive, the non-permanent adhesive non-permanent at least with respect to the adhesion of the application medium to the base film.

24. The system of claim 23, wherein the identification code applicator is further configured to kiss-cut the carrier medium and the base film approximately around the identification code.

25. The system of claim 23, wherein the carrier medium having the identification code disposed thereon is configured to be peeled from the application medium.

26. The system of claim 22, wherein the identification code applicator is further configured to thermally print the identification code in ink on the carrier medium.

27. The system of claim 22, wherein the identification code applicator is further configured to print the identification code by particulate on the carrier medium.

28. The system of claim 22, wherein the identification code applicator is further configured to dispose on the carrier medium a second identification code that is not associated with the identification system.

29. The system of claim 21, further comprising an identification code applicator configured to dispose the identification code directly on an application surface of the target subject.

30. The apparatus of claim 21, wherein the identification code scanner is further configured to scan a conventional identification code that does not contain identification information associated the identification system.

31. The apparatus of claim 21, wherein the identification code scanner is further configured to distinguish the identification code from a second identification code that is not associated with the identification system.

32. The apparatus of claim 21, wherein the identification code scanner is further configured to block the scan of the second identification code.

33. The system of claim 21, further comprising an encoder configured to encode the identification code, the identification code derived from the target data.

34. The system of claim 21, further comprising a decoder configured to decode the identification code.

35. The system of claim 21, further comprising a database, wherein the target data is stored in the database and the data access module is configured to access the target data in the database.

36. The system of claim 21, further comprising a decoder and a database, wherein the decoder, the database, and the data access module are located on a computer, the identification code scanner further configured to communicate the identification code to the computer.

37. The system of claim 21, further comprising a portable electronic device configured to receive the identification code from the identification code scanner.

38. The system of claim 37, wherein the portable electronic device is further configured to access the target data stored on a database on a computer.

39. The system of claim 21, further comprising a portable printer.

40. The system of claim 21, further comprising a user interface configured to communicate at least a portion of the identification information to a user.

41. A method for identifying a target subject, the method comprising:
removing a carrier medium from an application layer, the carrier medium having an identification code disposed thereon, the identification code comprising an encoded identifier of identification information corresponding to a target subject; and
disposing the carrier medium semi-permanently on a substantially smooth and durable application surface of the target subject, wherein the target subject comprises one of a human and an animal.

42. The method of claim 41, wherein disposing the carrier medium on the application surface further comprises maintaining the identification code accessible for scanning.

43. The method of claim 41, further comprising encoding the identification code, the identification code derived from the identification information corresponding to the target subject.

44. The method of claim 41, further comprising disposing the identification code on the carrier medium.

45. The method of claim 44, further comprising disposing the identification code in reverse on a first side of the carrier medium.

46. The method of claim 41, further comprising disposing the carrier medium on a base film using a base film adhesive, wherein the base film is a laminate.

47. The method of claim 41, further comprising removably disposing the carrier medium on an application medium.

48. The method of claim 41, further comprising cleaning the application surface prior to disposing the carrier medium on the application surface.

49. The method of claim 41, further comprising disposing a protective coating on the carrier medium after the carrier medium is disposed on the application surface.

50. The method of claim 41, further comprising scanning the identification code.

51. The method of claim 41, further comprising decoding the identification code.

52. The method of claim 41, further comprising accessing the target data from a database based on the identification code.

53. The method of claim 41, further comprising communicating the identification code to a portable electronic device.

54. The method of claim 41, further comprising communicating a portion of the identification information to a user in response to scanning the identification code and retrieving the identification information.

55. A method for identifying a target subject, the method comprising:
encoding an identification code, the identification code derived from identification information corresponding to a target subject, wherein the target subject comprises one of a human and an animal;
disposing the identification code on the carrier medium;
disposing the carrier medium on a base film using a base film adhesive;
removably disposing the base film on an application medium;
removing the carrier medium from an application layer, the carrier medium having the identification code disposed thereon;
disposing the carrier medium semi-permanently on a substantially smooth and durable application surface of the target subject;
scanning the identification code;
decoding the identification code;
accessing the target data from a database based on the identification code; and
communicating at least a portion of the identification information to a user.

56. A method for identifying a target subject, the method comprising:
encoding an identification code, the identification code derived from identification information corresponding to a target subject, wherein the target subject comprises one of a human and an animal;
disposing the identification code directly on an application surface of the target subject;
scanning the identification code;
decoding the identification code;
accessing the target data from a database based on the identification code; and
communicating at least a portion of the identification information to a user.

57. An apparatus to identify a target subject, the apparatus comprising:
means for removing a carrier medium from an application layer, the carrier medium having an identification code disposed thereon, the identification code comprising an encoded identifier of identification information corresponding to a target subject; and
means for disposing the carrier medium semi-permanently on a substantially smooth and durable application surface of the target subject, wherein the target subject comprises one of a human and an animal.

58. The apparatus of claim 57, further comprising means for scanning the identification code.

59. The apparatus of claim 57, further comprising means for receiving the identification code from the identification code scanner and means for accessing target data corresponding to the identification code.

60. The apparatus of claim 57, further comprising means for communicating at least a portion of the identification information to a user.

61. A method for distinguishing identification codes, the method comprising:
scanning a first identification code having a first format and a first data content;
comparing the first format to a second format, wherein the second format is predetermined to be unique;
comparing the first data content to a second data content, wherein the second data content is predetermined; and
determining if the first format and first data content of the first identification code are similar to the second format and second data content.

62. The method of claim 61, further comprising accepting the first identification code if the first format and first data content are similar to the second format and second data content.

63. The method of claim 61, further comprising rejecting the first identification code if the first format is dissimilar from the second format.

64. The method of claim 61, further comprising rejecting the first identification code if the first data content is dissimilar from the second data content.

65. The method of claim 61, further comprising employing a plurality of flags to determine if the first format and first data content of the first identification code are similar to the second format and second data content.

66. A method for scanning an identification code, the method comprising:
scanning an first identification code disposed on a target subject;
scanning a second identification code not disposed on the target subject, the second identification code having a distinct format from the first identification code; and
distinguishing between the first identification code and the second identification code.
